(19) United States
(12) Patent Application Publication
(10) Pub. No.: US 2026/0175471 A1
(43) Pub. Date: Jun. 25, 2026

(54) METHODS FOR FABRICATING AND/OR FINISHING STRUCTURAL INSULATED PANELS

(71) Applicant: NEXII BUILDING SOLUTIONS INC., Vancouver (CA)

(72) Inventors: Benedict Dombowsky, Squamish (CA); Louis Dombowsky, Squamish (CA); Mark Dombowsky, Moose Jaw (CA); Michael Dombowsky, Moose Jaw (CA); Braden Dombowsky, Peachland (CA)

(21) Appl. No.: 19/129,114

(22) PCT Filed: Nov. 9, 2023
(86) PCT No.: PCT/CA2023/051499

§ 371 Date: May 12, 2025

Related U.S. Application Data
(60) Provisional application No. 63/424,429, filed on Nov. 10, 2022.

(51) Int. Cl. B28B 1/30; B28B 11/00; B28B 11/04; B28B 11/08; B28B 11/24; E04C 2/04; E04C 2/284

(52) U.S. Cl. CPC B28B 1/30; B28B 11/001; B28B 11/048; B28B 11/0818; B28B 11/0872; B28B 11/24; E04C 2/044; E04C 2/284

(57) ABSTRACT

Example embodiments of the described technology provide methods for fabricating structural insulated panels (SIPs). An example embodiment provides a method for fabricating a SIP. The method may comprise fabricating opposing first and second cementitious faces of the SIP. The first cementitious face may be fabricated in a first portion of a mold and the second cementitious face may be fabricated in a second portion of the mold. The method may also comprise coupling the first and second portions of the mold together. The method may also comprise introducing an insulative material into the mold to at least partially fill a void between the first and second cementitious faces. The method may also comprise at least partially curing the first and second cementitious faces and the insulative material. The method may also comprise extracting the at least partially cured SIP from the mold. Example embodiments also provide methods for applying desired finishes to SIPs.

### CROSS-REFERENCE TO RELATED APPLICATIONS

This application claims priority from U.S. Application No. 63/424,429 filed 10 Nov. 2022 and entitled METHODS FOR FABRICATING AND/OR FINISHING STRUCTURAL INSULATED PANELS which is hereby incorporated herein by reference for all purposes. For purposes of the United States of America, this application claims the benefit under 35 U.S.C. § 119 of U.S. application No. 63/424,429 filed 10 Nov. 2022 and entitled METHODS FOR FABRICATING AND/OR FINISHING STRUCTURAL INSULATED PANELS.

### FIELD

This invention relates to building panels and in particular prefabricated structural insulated panels (SIPs). Example embodiments provide methods for fabricating structural insulated panels and/or for applying desired finishes to structural insulated panels.

### BACKGROUND

Constructing a building is typically an extensive project involving significant amounts of time and/or resources (e.g. labour, energy, materials, etc.). Moreover, the carbon footprint of a building built using existing systems and methods can be large.

Reducing the amount of time and/or resources required to construct a building can be desirable. Reducing the carbon footprint of a building can also be desirable.

With more environmentally stringent building codes being passed regularly, reducing the amount of resources used to construct a building and the carbon footprint of the building is increasingly becoming a requirement to be in compliance with new building codes.

One way the amount of time and/or resources required can be reduced is by constructing the building using prefabricated panels. Existing prefabricated panels however are heavy, cannot provide the required performance characteristics, etc.

There remains a need for practical and cost effective ways to fabricate prefabricated building panels using systems and methods that improve on existing technologies.

### SUMMARY

This invention has a number of aspects. These include, without limitation:
methods for rapidly fabricating a structural insulated panel (SIP);
methods for directly printing a desired colour pattern onto a surface (or surfaces) of a SIP;
methods for directly printing a desired three-dimensional texture onto a surface (or surfaces) of a SIP;
methods for installing components onto an existing surface (or surfaces) of a SIP;
methods for embedding components at least partially into a surface of a SIP that is printed onto the SIP;
methods for finishing a surface (or surfaces) of a SIP.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a perspective view of an example prefabricated structural insulated panel.

FIG. 2 is a block diagram of a method according to an example embodiment of the invention.

FIG. 2A is a cross-sectional view of an example cementitious face.

FIG. 3A is a perspective view of an example mold for fabricating a structural insulated panel.

FIG. 3B is a partial perspective view of an example portion of a mold for fabricating a structural insulated panel.

FIGS. 3C to 3E illustrate an example mold for fabricating a structural insulated panel. FIG. 3C is a perspective view of the example mold. FIG. 3D is a front view of the example mold. FIG. 3E is a perspective view of the example mold.

FIGS. 4A to 4E are schematic illustrations of example steps of a process for fabricating a structural insulated panel.

FIG. 5 is a block diagram of a method according to an example embodiment of the invention.

FIG. 6A is a schematic illustration of a computer controlled printer printing an example three-dimensional texture directly onto a structural insulated panel according to an example embodiment of the invention.

FIG. 6B is a schematic illustration of a computer controlled printer printing an example three-dimensional texture directly onto a structural insulated panel according to an example embodiment of the invention.

FIGS. 6C and 6D are schematic illustrations of a computer controlled printer embedding example components onto a panel according to an example embodiment of the invention.

FIG. 6E is a schematic illustration of a computer controlled printer embedding example components onto a panel according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

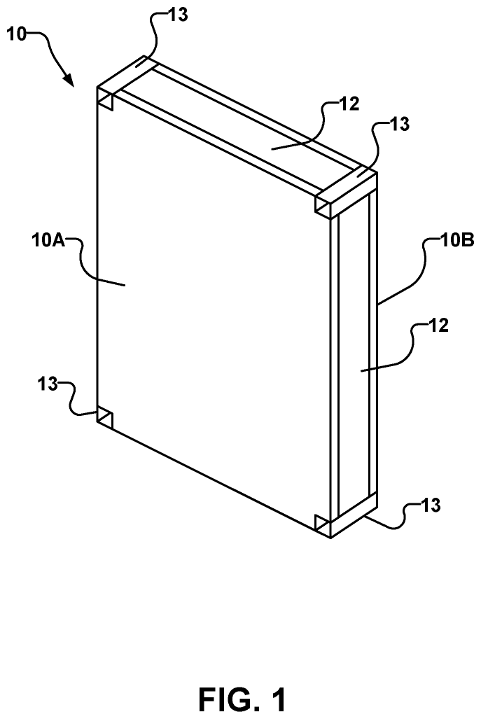

FIG. 1 is a perspective view of an example prefabricated structural insulated panel (SIP) 10. Panel 10 comprises opposing cementitious faces 10A and 10B (e.g. exterior face 10A and interior face 10B or vice versa). Cementitious faces 10A and 10B comprise a cementitious material. Panel 10 also comprises an insulative core 12 between cementitious faces 10A and 10B. Panel 10 may comprise one or more embedded elements 13 such as (non-limiting):
one or more connectors (e.g. for connecting the panel to a structure or an adjacent panel);
a structural frame;
one or more structural elements (e.g. structural ribs);
one or more plumbing components (e.g. pipes, valves, etc.);
one or more HVAC components (e.g. ducting, air intakes, air outlets, etc.);
one or more electrical components (e.g. electrical conduits, electrical outlets, etc.);
etc.

A set of panels 10 may be used to construct a building, to insulate an existing building and/or the like. Preferably panels 10 are plant finished (e.g. fully manufactured at a factory). Panels 10 may preferably be easily and quickly shipped to a construction site (e.g. on a flatbed truck, within shipping containers, on railway cars, etc.). Panels 10 may, for example, comprise wall panels, roof panels, floor panels, foundation panels, pavement panels, etc. Once panels 10 arrive at the construction site they may be easily and quickly assembled together.

One aspect of the invention described herein provides a method for fabricating prefabricated SIPs such as panel 10. In some embodiments the method described herein rapidly fabricates a panel. In some embodiments the panel is fabricated in or less than about 4 hours, or in or less than about 2 hours, or in or less than about one hour. Additionally, or alternatively, the method described herein may fabricate a panel with a high degree of accuracy such that the panel provides one or more cementitious faces (e.g. faces 10A and/or 10B) suitable for the application of a desired finish. In some embodiments the one or more cementitious faces require no or very little pre-finishing surface preparation (e.g. require no or very little grinding, leveling, smoothing, etc. of faces 10A and/or 10B prior to the application of a desired finish). In some embodiments the one or more cementitious faces may be substantially flat and/or smooth. In some embodiments the cementitious faces may be substantially uniform and texturally consistent. In some embodiments the cementitious faces may be generally flawless, i.e. without any significant surface protuberances, pitting, ridges, blemishes, scarring or other unintended surface deviation which may interfere with a finishing method (e.g. interfere with a printer head applying a desired finish, produce a finish with an undesired appearance, etc.) thereby requiring pre-finishing surface treatment. The desired finish applied to the one or more cementitious faces may be a finish as described herein.

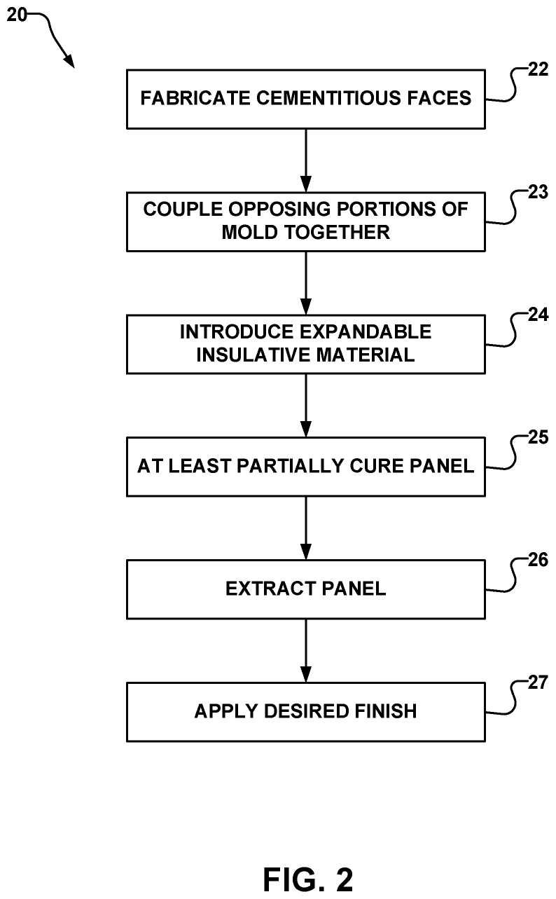

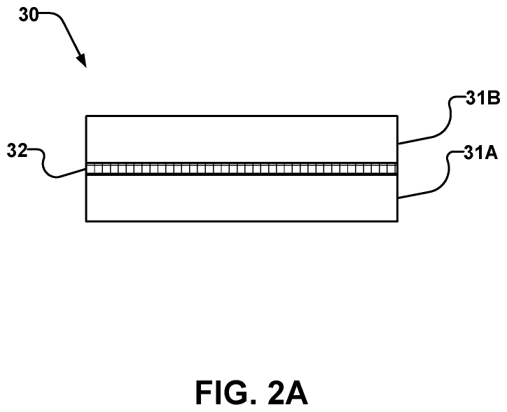

FIG. 2 is a block diagram which illustrates an example method 20 for rapidly fabricating a SIP such as panel 10.

In block 22 opposing cementitious faces (e.g. faces 10A and 10B) of a panel are fabricated. Preferably, each cementitious face comprises a cementitious material and one or more reinforcing elements. The one or more reinforcing elements may, for example, comprise fiberglass sheets, welded wire mesh, graphene, carbon nanoparticles, steel fibers, polypropylene fibers, nylons, polyester fibers, acrylic fibers, aramid fibers, asbestos, hemp, coir fibers, glass fibers, poly vinyl alcohol (PVA) fibers, recycled tire fibers (RTF), carbon fibers, etc. As shown in FIG. 2A a cementitious face 30 may, for example, comprise a fiberglass sheet 32 sandwiched between cementitious layers 31A and 31B. In some embodiments fiberglass sheet 32 is closer to an outer surface of the panel than a surface of the insulative core. In some embodiments each cementitious face comprises plural alternating layers of cementitious material and reinforcing elements (e.g. a cementitious face which comprises a first cementitious layer followed by a first layer of reinforcing elements followed by a second cementitious layer followed by a second layer of reinforcing elements following by a third cementitious layer and so on). In some embodiments the one or more reinforcing elements are interspersed within the cementitious material.

The cementitious faces may be fabricated using opposing portions of a mold. Each cementitious face may be cast or formed in its respective portion of the mold. Advantageously, the cementitious faces may be fabricated either horizontally or vertically. In some embodiments the cementitious material of the cementitious face is sprayed into each portion of the mold. One or more reinforcing elements (e.g. fiberglass sheets, welded wire mesh, etc.) may, for example, be layered over or interspersed within the sprayed cementitious material. A subsequent layer of cementitious material may be sprayed over the reinforcing element(s). In some embodiments the one or more reinforcing elements are positioned into the mold prior to the cementitious material being sprayed. In some embodiments the one or more reinforcing elements are interspersed with the cementitious material prior to the cementitious material being introduced into the mold. In some embodiments the cementitious material is poured or cast into the mold. In such embodiments the reinforcing elements may be added to the mold before, during or after the cementitious material is poured or cast.

The cementitious faces may be about ⅛ of an inch thick. In some embodiments the cementitious faces have a thickness in a range from about ¼ of an inch to about 1 inch. In some embodiments the cementitious faces have a thickness in a range from about ¼ of an inch to about 3 inches.

As described elsewhere herein, a panel (e.g. panel 10) may comprise one or more embedded elements (e.g. embedded elements 13). In some embodiments such embedded elements are embedded into the cementitious material of the cementitious faces while the cementitious faces are being fabricated. In some embodiments one or more of the embedded elements are positioned in a corresponding mold prior to the cementitious material being introduced into the mold. In some embodiments the embedded elements are embedded within only one of the cementitious faces.

Forming or casting block-outs may be positioned within a mold to create voids in the cementitious material (e.g., for windows, etc.). Additionally, or alternatively, texturing patterns may be positioned within a mold to create a desired pattern in the cementitious facings (e.g. a brick pattern, wood grain, etc.).

In block 23 opposing portions of the mold are coupled together. Typically, the opposing portions of the mold are coupled together once the cementitious material of the cementitious faces is at least partially set or cured. In some embodiments the opposing portions of the mold may be coupled within about 45 minutes or less of the cementitious material being introduced into the mold.

Each portion of the mold may comprise one or more alignment elements configured to guide each portion of the mold into proper alignment with the opposing portion. For example, one or more guiding pins which pass through one or both of the portions of the mold may align the portions of the mold with respect to one another.

Once the opposing portions of the mold are properly aligned with respect to one another, the opposing portions of the mold are locked in position with respect to one another with a locking mechanism. The locking mechanism may, for example, comprise clasps or other interlocking mechanisms. In some embodiments the locking mechanism comprises a hydraulic mechanism. The locking mechanism resists lateral expansion forces exerted on the portions of the mold. In some embodiments the locking mechanism at least partially aligns the portions of the mold with respect to one another.

In block 24 a void (or cavity) between the opposing cementitious facings is filled with an insulative material. In some embodiments the insulative material comprises an expandable insulative material such as an expandable foam insulative material. Upon being inserted into the mold, the expandable insulative material expands in volume. Insertion of the insulative material at least partially fills the void between the cementitious faces and generates an insulative core of the panel (e.g. core 12). In some embodiments the inserted insulative material cures quickly. In some embodiments the insulative material cures in about 45 minutes or less. Due to extensive pressure that may be generated as part of this process, the mold must be strong enough to withstand lateral expansion of the insulative material. For example, if the insulative material comprises polyurethane, lateral expansion pressures in the range from about 4 psi to about 12 psi may be exerted on the mold. As described elsewhere herein, the locking mechanism may resist lateral expansion forces exerted on the portions of the mold.

Additionally, or alternatively, curing of the cementitious material and/or the insulative material may generate large amounts of heat. In some cases curing of the cementitious material and/or the insulative material raises a temperature of the panel to about 160° F. (about 71° C.). The mold preferably is configured to withstand such heat.

In some embodiments the mold is maintained at a minimum threshold temperature for at least a portion of method 20. For example, the mold may be maintained at a minimum threshold temperature (e.g. about 120° F. (about 49° C.)) prior to introduction of the insulative material and/or once the insulative material is introduced into the mold for the insulative material to cure properly. In some embodiments the mold is maintained at a threshold temperature to control or accelerate curing of cementitious material. In some embodiments the mold comprises one or more heating elements (e.g. electrical wiring running through the portions of the mold, radiant water heating pipes running through the portions of the mold, etc.) to maintain the mold at the minimum threshold temperature.

In some embodiments, the insulative material bonds directly to the cementitious faces. In some embodiments the insulative material at least partially bonds opposing sides (e.g. opposing halves comprising opposing cementitious faces) of the panel together.

In some embodiments a series of molds for a plurality of panels are positioned adjacent one another. Positioning a plurality of molds adjacent one another may advantageously reduce the likelihood of any one of the molds undesirably expanding laterally (e.g. adjacent molds prevent lateral expansion of a particular mold).

By filling the void with an injectable (or otherwise introducible) insulative material, the need to source, transport and store large volumes of solid insulative foam materials (such as EPS foam) is eliminated. The insulative material may be transported and stored in liquid form. Prior to being introduced into the mold the insulative material may be combined with a blowing agent. Additionally, extensive amounts of time previously required to prepare solid foam (e.g. EPS foam) for use in SIPs (e.g. cutting, milling, gluing, etc.) is no longer required with the mold introducible insulative material being used.

In some embodiments the insulative material comprises:
a urethane foam such as polyurethane;
a thermoset plastic such as polyisocyanurate (which may be known as PIR, Polyiso or ISO in the art);
a tri polymer-based resin;
a phenolic resin or phenolic mineral foam;
polyvinyl chloride (PVC);
a soy based foam;
expanded polystyrene (EPS);
extruded polystyrene (XPS);
two or more of the above;
etc.

In some embodiments the blowing agent comprises:
a hydrofluoroolefin (HFO) based solution;
hydrochlorofluorocarbons (HCFCs);
hydrocarbons (HCs);
a Honeywell Solstice® Liquid Blowing Agent (LBA);
a Honeywell Solstice® Gas Blowing Agent (GBA);
two or more of the above;
etc.

The panel is cured (e.g. the insulative material, the cementitious faces, etc.) in block 25. Once the panel is sufficiently cured, the panel is extracted from the mold in block 26. As described elsewhere herein, the panel may advantageously be sufficiently cured in, for example, less than about 4 hours. In some embodiments, the panel is sufficiently cured in about 2 hours or less. In some embodiments the panel need not be fully cured prior to being extracted from the mold.

In block 27, a desired finish is optionally applied to the extracted panel.

In some embodiments applying the desired finish comprises coupling a cladding to the cementitious facings, painting the panel, etc.

In some embodiments applying the desired finish comprises printing a desired finish directly onto one or more of the cementitious faces (or other surfaces) of the panel. In some embodiments the desired finish comprises a photorealistic finish. Advantageously, since the panel fabrication method described herein may produce panels comprising one or more cementitious faces suitable for the application of a desired finish, the desired finish may, for example, be printed onto the cementitious face(s) immediately after the panel has been extracted from the mold. Since the cementitious face(s) may be suitable for the application of a desired finish, it may not be necessary to prepare the panel (e.g. grind or smooth a cementitious face, etc.) prior to printing the desired finish onto the panel.

It is emphasized that one or more adaptations to method 20 may be made. For example (non-limiting):
A panel to be fabricated with method 20 may comprise only one cementitious face (i.e. the panel need not comprise two opposing cementitious faces). For example, a cementitious face may be fabricated in only one portion of the mold. In such case the insulative material may, for example, at least partially fill a void between the single cementitious face and a casting bed of the opposing portion of the mold. The opposing face of such panel may be formed by the insulative material or may comprise an alternative desired face material as described elsewhere herein.
One or both portions (e.g. portions 35A and 35B described elsewhere herein) of the mold may fabricate panel sides which comprise one or more desired materials coupled to either a cementitious face or the insulative core of the panel. For example, a desired cladding material may be inserted into one or both portions of the mold prior to the cementitious material and/or the insulative material being introduced. In some embodiments the desired cladding material comprises a desired finish that is printed as described elsewhere herein onto a substrate. In some embodiments a desired face material (e.g. magnesium board, gypsum drywall, oriented strand board (OSB), plywood, sheet metal, etc.) is inserted into a portion of the mold. In some such embodiments cementitious material need not be introduced into the portion of the mold comprising the desired face material. The insulative material may at least partially adhere the desired face material to the panel.
The portions of the mold may not be mirror symmetric. In some embodiments each portion of the mold produces a different corresponding side of the panel. For example, one portion of the mold may form a bare cementitious face while the other portion of the mold adheres a cladding layer to the panel. In some embodiments the portions of the mold have different depths. For example, one portion of the mold may form 70% of the panel's side edges while the other portion of the mold forms 30% of the panel's side edges. As another example, one portion of the mold may form 80% of the panel's side edges while the other portion of the mold forms 20% of the panel's side edges.
One or more cementitious edge surfaces of the panel may be fabricated. In some embodiments cementitious material is introduced (e.g. by spraying cementitious material) onto one or more edge surfaces of corresponding formwork of the portions of the mold to fabricate corresponding one or more cementitious edge surfaces of the panel. The one or more cementitious edge surfaces may be continuous with a cementitious face. In some embodiments the one or more cementitious edge surfaces have at least one characteristic that is different than the cementitious face (e.g. different cementitious material, different thickness, different reinforcing element, reinforcing element may not be present, etc.). In some embodiments one or more cementitious edge surfaces are fabricated even if a panel does not comprise a cementitious face. In some embodiments cementitious edge surfaces are fabricated to cover a complete periphery of a corresponding portion of the panel.
The mold may be pre-heated and/or heated (e.g. as described elsewhere herein) through at least a portion of the fabrication process to expedite curing of one or both of the cementitious material and the insulative material.
One or more coupling members may be introduced between the opposing portions of the panel to strengthen the coupling between the opposing portions of the panel. For example, one or more coupling members may be introduced between the opposing portions of the panel prior to the insulative material being introduced along the seam formed between the opposing portions of the panel. The one or more coupling members may, for example, comprise an epoxy coated wire mesh, fiber mesh, one or more mechanical fasteners (e.g. stainless steel fasteners, basalt fasteners, fiber-reinforced plastic (FRP) fasteners, etc.), etc. In some embodiments, the one or more coupling members are not thermally conductive (or have a low thermal conductivity). In some embodiments the insulative material at least partially separates cementitious edges of the opposing portions of the panel from one another.

In some embodiments method 20 may be performed at different sites. For example, equipment (e.g. one or more molds) and required materials (e.g. cementitious material, insulative material, etc.) may be shipped to a construction site or proximate to a construction site. One or more panels may then be fabricated at the mobile site. In some embodiments the mobile site is climate controlled (e.g. temperature controlled, etc.). In some such embodiments panels are fabricated shortly before being required (e.g. shortly before installation).

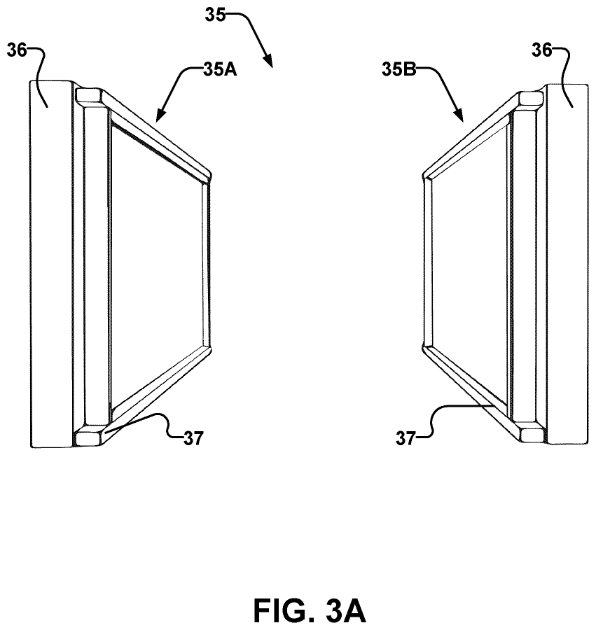

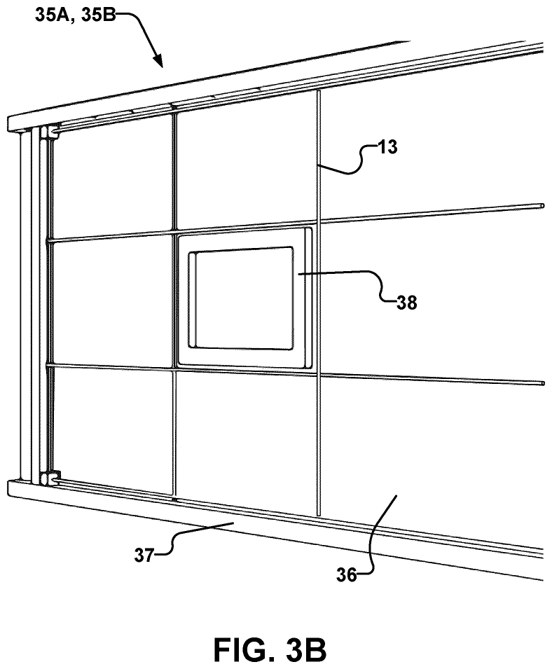

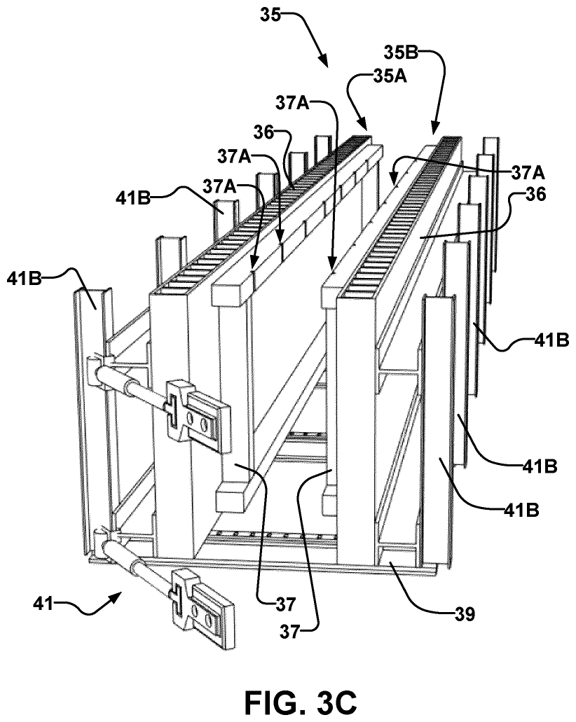

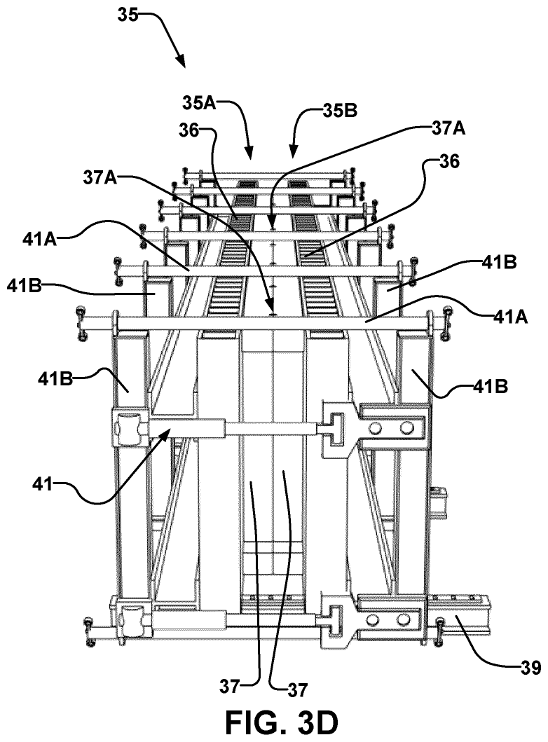

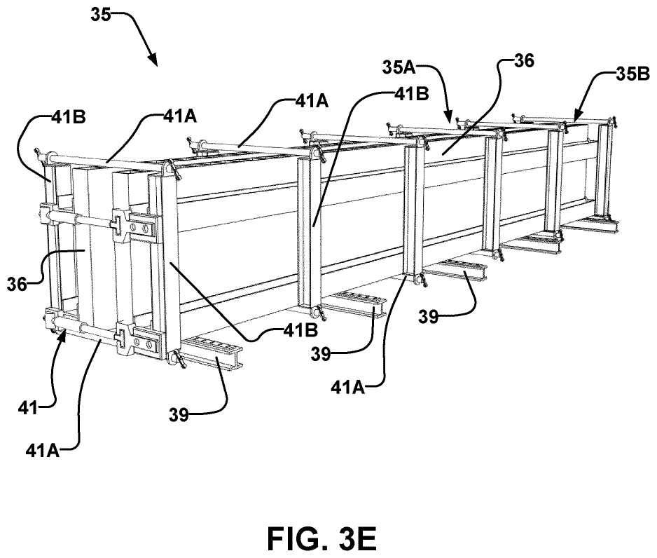

FIG. 3A is a perspective view of an example mold 35 for making a SIP according to method 20. Mold 35 comprises opposing portions 35A and 35B. As described elsewhere herein portions 35A and 35B may be mirror symmetric or may not be mirror symmetric. In some embodiments portions 35A and 35B are equal halves of mold 35. When brought together, opposing portions 35A and 35B collectively form mold 35 for making a SIP. Each of opposing portions 35A and 35B comprise a casting bed 36 and formwork 37. In some embodiments formwork 37 is magnetically coupled to casting bed 36.

FIG. 3B is a partial perspective view of an example portion of mold 35 (e.g. portion 35A or 35B). As shown in FIG. 3B the illustrated example portion comprises embedded elements 13 and a blockout 38 for generating an aperture configured to receive, for example, a window. Blockout 38 may be magnetically coupled to casting bed 36.

FIGS. 3C to 3E illustrate another example of mold 35. Cross-bars 41A may extend between opposing portions of mold 35. Cross-bars 41A may, for example, at least partially align portions 35A and 35B of mold 35 together. Additionally, or alternatively, cross-bars 41A may at least partially assist with preventing lateral separation of portions 35A and 35B relative to one another. In some embodiments cross-bars 41A extend between opposing posts 41B. In some embodiments cross-bars 41A extend along both upper and lower surfaces of mold 35. In some embodiments cross-bars 41A extend along only an upper or lower surface of mold 35. In some embodiments a length of cross-bars 41A is variable. Posts 41B may be coupled to portions 35A and 35B as shown in FIGS. 3C to 3E.

In some embodiments rails 39 support mold 35. In some embodiments rails 39 at least partially facilitate movement of portions 35A and 35B relative to one another.

In some cases mold 35 shown in FIGS. 3C to 3E fabricates a panel that is about 4 feet by about 32 feet.

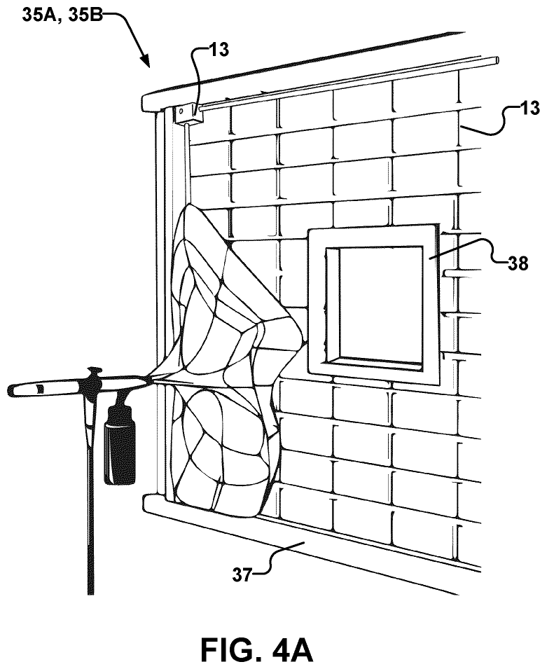

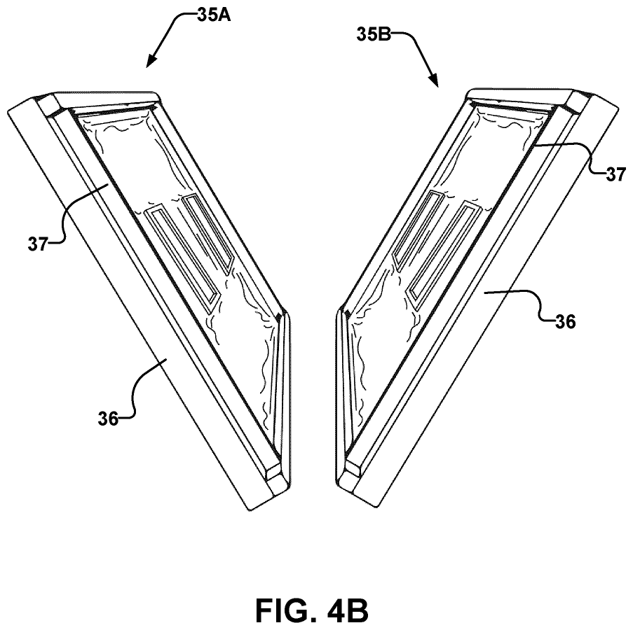

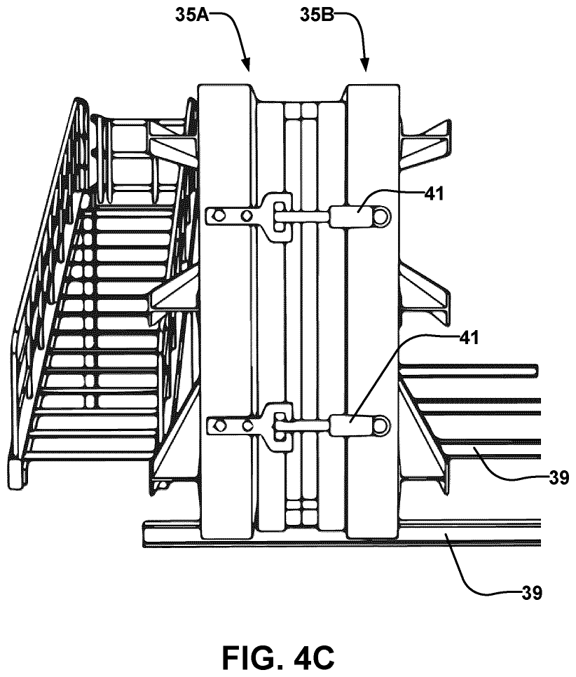

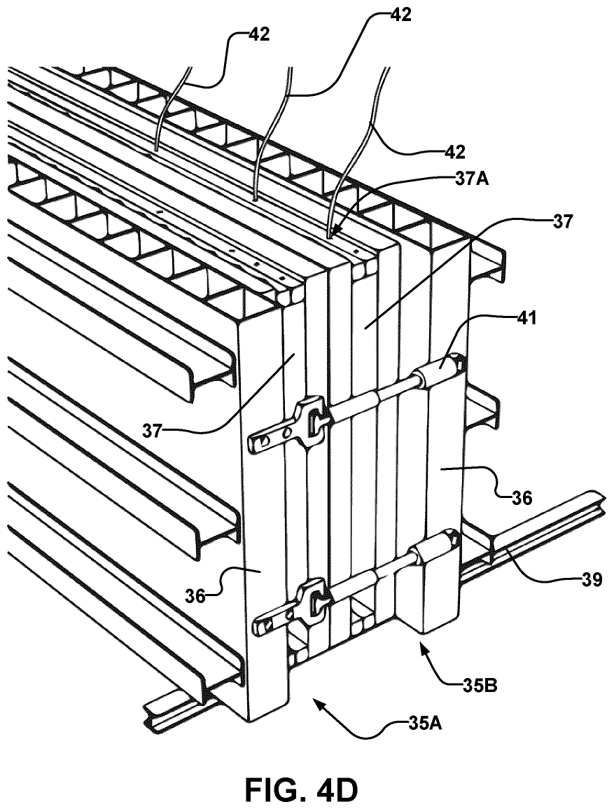

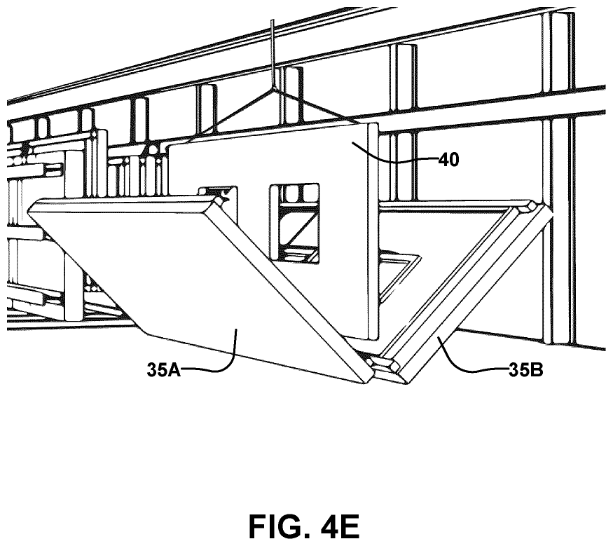

FIGS. 4A to 4E schematically illustrate example fabrication of an example panel 40 according to method 20. In FIG. 4A, cementitious material to form a cementitious face is sprayed into one portion (e.g. portion 35A or 35B) of mold 35. In FIG. 4B, once cementitious material has been introduced into both of portions 35A and 35B, portions 35A and 35B are brought together. In FIG. 4C, portions 35A and 35B are coupled together and locked with example locking mechanism 41. Locking mechanism 41 may comprise a hydraulic mechanism. In FIG. 4D, one or more insulative material supply lines 42 are coupled to mold 35 and the insulative material is inserted into mold 35 (e.g. to fill the void between the opposing cementitious faces). In FIG. 4E, portions 35A and 35B of mold 35 are uncoupled and panel 40 is extracted.

In some embodiments formwork 37 (e.g. of portions 35A and/or 35B) defines one or more passage ways for the insulative material. For example, as shown in FIGS. 3C and 3D, formwork 37 may define passages 37A for the insulative material to be introduced into the mold. In some embodiments one or more elements (e.g. one or more nozzles, etc.) of insulative material supply lines 42 are couplable with corresponding ones of the passage ways (e.g. passages 37A). In some embodiments passages 37A are cylindrical (e.g. each portion of mold 35 defines a semi-cylindrical passage). In some embodiments only one portion (e.g. portion 35A or 35B) comprises passages 37A.

In some embodiments fabrication of a panel as described herein is at least partially automated (e.g. with one or more computer-controlled mechanisms such as robotic arms, computer-controlled material dispensers or supply lines, etc.). For example, cementitious material may be autonomously introduced into a respective portion of mold 35. Additionally, or alternatively, portions 35A and 35B of mold 35 may be autonomously brought together. Additionally, or alternatively, portions 35A and 35B of mold 35 may be autonomously locked together (e.g. with locking mechanism 41). Additionally, or alternatively, portions 35A and 35B of mold 35 may be autonomously uncoupled from one another. Additionally, or alternatively, panel 40 may be autonomously extracted from mold 35.

Another aspect of the invention provides a method for printing desired finishes (e.g. a brick pattern, a wood pattern, a marble pattern, one or more images, etc.) directly onto one or more surfaces of a SIP. Specifically, such method for printing a desired finish directly onto one or more surfaces of a SIP may be applied to print a desired finish onto any surface of a panel fabricated using the rapid fabrication method described elsewhere herein as well as any other SIP (e.g. any panel having an insulative core between two opposing rigid sheathing layers or any panel having an insulative core and at least one structural sheathing layer) such as an oriented strand board (OSB) SIP, a metal SIP, etc. In some embodiments the desired finish comprises a photorealistic finish. Additionally, or alternatively, a desired finish may be printed directly onto a variety of surfaces such as, for example (non-limiting):
a cementitious surface;
a foam surface;
oriented strand board (OSB);
plywood;
sheet metal;
fiber-cement siding;
magnesium-oxide board;
fiberglass mat gypsum;
composite structural siding panels;
fiber reinforced plastic or polymer (FRP) laminate sheathing comprising fiber reinforced plastics or fiber reinforced polymers and one or more reinforcing materials such as plywood, woven or non-woven materials, stitched and/or chopped materials, mats of natural materials (e.g. flax, hemp, kanaf, etc.), mats of synthetic materials (e.g. polypropylene, nylon, polyvinyl chloride (PVC), polyvinyl alcohol (PVA), vectran, polyamide, carbon fiber, aramid, kevlar, spectra fabric, high modulus polyester, etc.);
etc.
   In some embodiments outer faces or skins of a panel onto which a finish will be printed are fireproof and/or weather resistant.

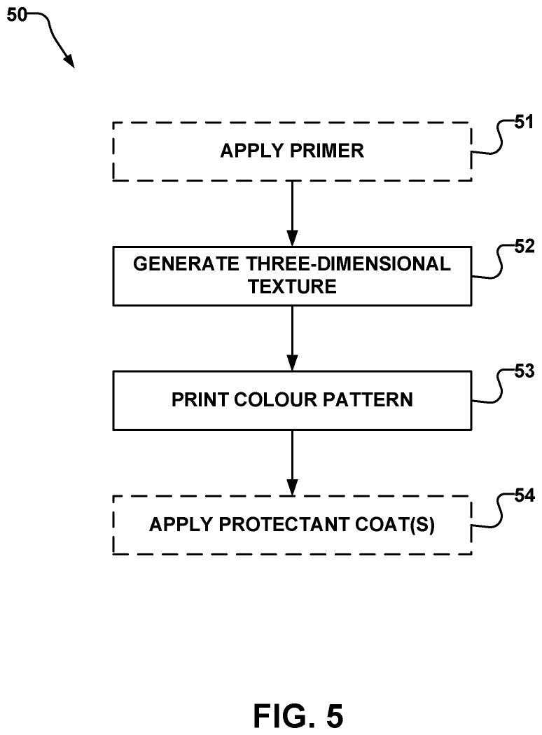

FIG. 5 is a block diagram which illustrates an example method 50 for printing a desired finish directly onto a surface of a SIP.

In block 51 a primer is optionally applied to the surface of the SIP. Additionally, or alternatively, a waterproofing membrane may be applied to the surface of the SIP.

In block 52 a curable material is iteratively applied layer-by-layer to the surface of the SIP to generate a desired three-dimensional texture on the surface of the SIP (e.g. a brick pattern with recessed mortar lines). Preferably the curable material is cured prior to a subsequent layer being printed on the surface of the SIP. In some embodiments the curable material comprises a UV curable material. For example, a layer of the curable material may be instantaneously cured by exposure to UV light upon the curable material being deposited. In some embodiments the generated three-dimensional texture has a height of up to about ½ of an inch.

In block 53 a colour pattern is printed onto the generated three-dimensional texture to generate a desired visual finish (e.g. for the brick texture to look like real brick). In some embodiments the desired visual finish comprises a photorealistic finish. For example, the colour pattern may be printed according to the CMYK (cyan, magenta, yellow and key (black)) colour model. As another example, the colour pattern may be printed according to the RGB (red, green, blue) colour model.

In block 54 one or more protectant coats may optionally be applied over the printed colour pattern. Preferably the protectant coat comprises a clear coat. The protectant coat(s) may, for example, reduce the likelihood of colours fading upon exposure to sunlight, degradation of the printed material upon further exposure to UV light, etc. In some embodiments the protectant coat generates a matte finish. In some embodiments the protectant coat generates a glossy finish.

Method 50 may, for example, be performed by a computer-controlled printing device (e.g. a CNC printer). The printing device may be controlled based on a digital representation (or representations) of the desired finish (or finishes) to be applied to the surface(s) of the SIP. In some embodiments the printing device comprises inkjet printer heads configured to deposit desired amounts of material at corresponding locations on the surface of the SIP.

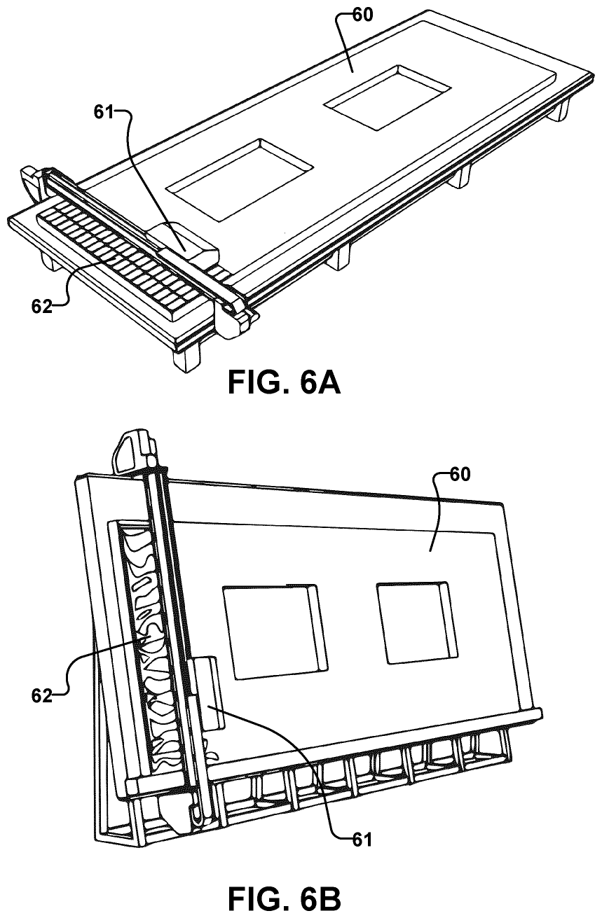

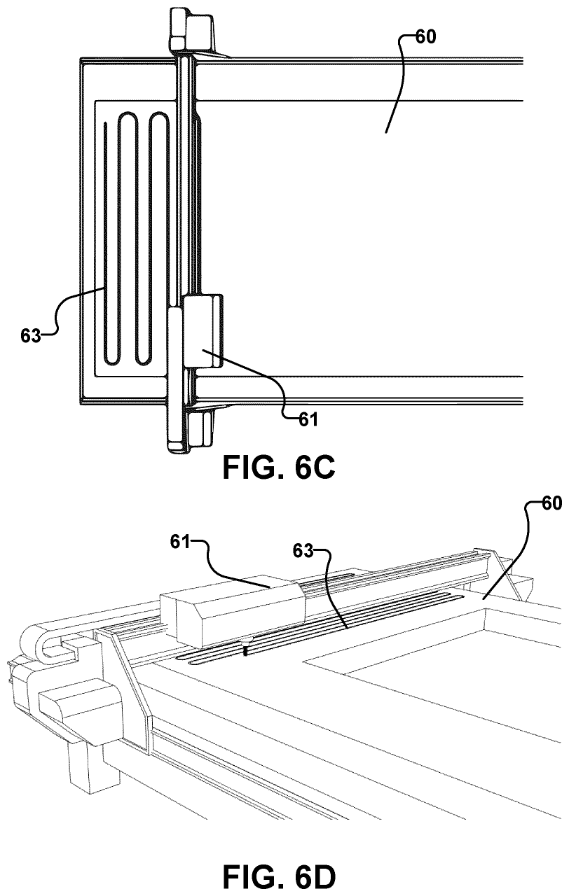

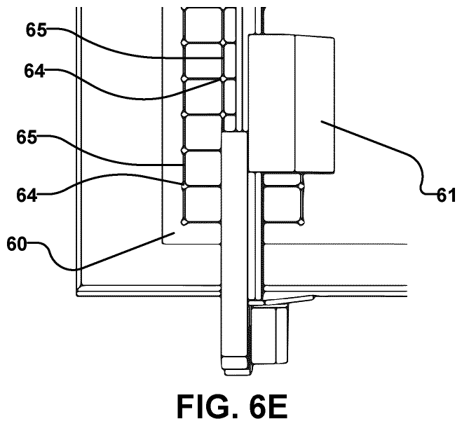

FIG. 6A illustrates an example computer-controlled printer 61 directly printing a texture 62 (e.g. a brick pattern with mortar lines) onto a panel 60. As another example, FIG. 6B illustrates computer-controlled printer 61 in an alternative orientation (e.g. a vertical rather than a horizontal orientation) directly printing a texture 62 (e.g. a stone pattern) onto panel 60.

In some embodiments block 52 comprises embedding one or more components into the printed three-dimensional texture to provide the SIP with additional functional characteristics. The one or more components may, for example, comprise electrical components such as electrical wiring, in-floor heating components, solar collectors for converting incident sunlight into electrical power, LED or LCD components (e.g. to convert at least a portion of the surface of the SIP into a display), one or more sensors (e.g. environmental sensors, motion sensors, voice sensors, etc.), etc. The one or more components may, for example, be embedded with the same computer-controlled printing device which also deposits the curable material to generate the three-dimensional texture. In some embodiments embedding the one or more components at least partially comprises printing an electrical circuit directly onto the surface of the SIP.

For example, FIGS. 6C and 6D illustrate printer 61 embedding example in-floor heating elements 63. As another example, FIG. 6E illustrates printer 61 embedding example sensors 64 connected together with wiring 65. Sensors 64 may, for example, monitor one or more characteristics of a panel (e.g. temperature, moisture content, etc.).

In some embodiments a desired three-dimensional texture is pre-generated on the surface of the SIP. For example, the three-dimensional texture may be generated by milling the surface of the SIP. As another example, the three-dimensional texture may be generated by casting the three-dimensional texture directly into the surface of the SIP (e.g. by placing texturing molds in a form used to case the surface of the SIP). In such embodiments block 52 may be skipped and method 50 may comprise printing a desired colour pattern directly onto the surface of the SIP with the pre-generated texture. In some such embodiments cavities may be generated (e.g. milled, cut-away, cast, etc.) to embed the one or more components described elsewhere herein which provide the SIP with additional functional characteristics.

Method 50 and or any individual step of method 50 may be performed for various sizes of SIPs. For example, method 50 and or any individual step of method 50 may be performed for SIPs ranging in size from about 2 feet by 2 feet to about 12 feet by 50 feet.

Additionally, or alternatively, method 50 and or any individual step of method 50 may, for example, be performed on any surface of a SIP.

Additionally, or alternatively, method 50 and or any individual step of method 50 may, for example, be performed for a SIP that is positioned horizontally or vertically or in any other position.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for fabricating a structural insulated panel (SIP), the method comprising:
fabricating opposing first and second cementitious faces of the SIP, the first cementitious face fabricated in a first portion of a mold and the second cementitious face fabricated in a second portion of the mold; coupling the first and second portions of the mold together;
introducing an insulative material into the mold to at least partially fill a void between the first and second cementitious faces; at least partially curing the first and second cementitious faces and the insulative material; and extracting the at least partially cured SIP from the mold.

2. The method according to claim 1 wherein coupling the first and second portions of the mold together comprises locking the first and second portions of the mold together such that the first and second portions of the mold resist lateral expansion forces exerted on the first and second portions of the mold by the insulative material.

3. The method according to claim 2 wherein the first and second portions of the mold are locked together with a locking mechanism.

4. The method according to claim 3 wherein the locking mechanism comprises releasable interlocking clasps.

5. The method according to claim 1 further comprising printing a desired finish directly onto at least a portion of a surface of the extracted SIP.

6. The method according to claim 5 wherein printing the desired finish comprises printing a colour pattern according to a digital representation of a desired photorealistic finish onto the surface of the extracted SIP.

7. The method according to claim 1 further comprising printing a desired three-dimensional texture onto at least a portion of a surface of the extracted SIP.

8. The method according to claim 7 further comprising applying a primer or waterproof membrane to the surface of the extracted SIP.

9. The method according to claim 7 further comprising iteratively depositing layers of curable material onto the surface of the extracted SIP to generate a desired three-dimensional texture.

10. The method according to claim 9 wherein the curable material comprises a UV curable material and the method comprises curing a deposited layer of the curable material with UV light.

11. The method according to claim 9 further comprising printing a colour pattern according to a digital representation of a desired photorealistic finish onto the generated three-dimensional texture.

12. The method according to claim 5 further comprising milling the surface of the extracted SIP to generate a desired three-dimensional texture.

13. The method according to claim 5 wherein a desired three-dimensional texture is formed into the surface of the extracted SIP.

14. The method according to claim 5 further comprising embedding one or more components onto the surface of the extracted SIP.

15. The method according to claim 5 further comprising depositing at least one protectant layer onto the surface of the extracted SIP.

16. The method according to claim 15 wherein the protectant layer blocks UV light.

17. The method according to claim 1 wherein the first and second cementitious faces of the SIP are formed horizontally or vertically.

18. The method according to claim 1 wherein fabricating opposing first and second cementitious faces of the SIP comprises embedding one or more element into at least one of the first and second cementitious faces prior to the first and second cementitious faces curing.

19. The method according to claim 1 wherein the SIP is fabricated in less than 4 hours.

20. A method for finishing a structural insulated panel (SIP), the method comprising:
printing a desired finish directly onto at least a portion of a surface of the SIP, the printing controlled according to a digital representation of the desired finish.

21.-38. (canceled)
